(19) United States
(12) Patent Application Publication
(10) Pub. No.: US 2022/0232493 A1
(43) Pub. Date: Jul. 21, 2022

(54) USER TERMINAL AND RADIO COMMUNICATION METHOD

(71) Applicant: NTT DOCOMO, INC., Tokyo (JP)

(72) Inventors: Hiroki Harada, Tokyo (JP); Shohei Yoshioka, Tokyo (JP); Satoshi Nagata, Tokyo (JP)

(73) Assignee: NTT DOCOMO, INC., Tokyo (JP)

(21) Appl. No.: 17/595,367

(22) PCT Filed: May 14, 2020
(86) PCT No.: PCT/JP2020/019336

§ 371 Date: Nov. 15, 2021

(30) Foreign Application Priority Data
May 17, 2019 (JP) 2019-094130

(51) Int. Cl. H04W 56/00; H04W 24/10; H04W 72/04; H04J 11/00

(52) U.S. Cl. CPC H04W 56/001; H04W 24/10; H04J 11/0069; H04W 72/0406; H04W 72/0446

(57) ABSTRACT

A user terminal according to one aspect of the present disclosure includes a receiving section that receives a synchronization signal block (SSB) having an index in a range of values from 0 to greater than 63 in a predetermined frequency range, and a control section that controls at least one of cell search or measurement using the SSB. According to one aspect of the present disclosure, processing based on SSB can be appropriately controlled.

### TECHNICAL FIELD

The present disclosure relates to user terminal and a radio communication method in a next-generation mobile communication system.

### BACKGROUND ART

In the universal mobile telecommunications system (UMTS) network, the specifications of long term evolution (LTE) have been drafted for the purpose of further increasing data rates, providing low delays, and so on (see Non Patent Literature 1). In addition, the specifications of LTE-Advanced (third generation partnership project (3GPP) Release (Rel.) 10 to 14) have been drafted for the purpose of further increasing capacity and advancement of LTE (3GPP Rel. 8 and 9).

Successor systems to LTE (for example, also referred to as 5th generation mobile communication system (5G), 5G+(plus), New Radio (NR), or 3GPP Rel. 15 or later) are also being studied.

### CITATION LIST

### Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010.

### SUMMARY OF INVENTION

### Technical Problem

In a future radio communication system (for example, NR), it is considered that a resource unit including a synchronization signal and a broadcast channel is defined as a synchronization signal block (SSB), and at least one of initial connection (cell search) and measurement is performed based on the SSB.

Further, in NR after Rel. 16, it is considered to use a frequency band higher than 52.6 GHz (above 52.6 GHz) (also referred to as a frequency range (FR) x or the like). However, in the frequency band higher than 52.6 GHz, it is assumed that a phase noise becomes large, a propagation loss becomes large, and that at least one of a peak-to-average power ratio (PAPR) and a PA having non-linearity has high sensitivity.

Thus, a new configuration of the SSB and a control method of processing (for example, at least one of initial connection (cell search) and measurement) based on the SSB are desired.

Therefore, it is an object of the present disclosure to provide a user terminal and a radio communication method capable of appropriately controlling processing based on the SSB.

### Solution to Problem

A user terminal according to one aspect of the present disclosure includes a receiving section that receives a synchronization signal block (SSB) having an index in a range of values from 0 to greater than 63 in a predetermined frequency range, and a control section that controls at least one of cell search or measurement using the SSB.

### Advantageous Effects of Invention

According to one aspect of the present disclosure, processing based on SSB can be appropriately controlled.

### BRIEF DESCRIPTION OF DRAWINGS

FIG. 1 is a diagram illustrating an example of FR.

FIG. 2 is a diagram illustrating an example of an SSB.

FIGS. 3A and 3B are diagrams illustrating an example of beam sweeping.

FIG. 4 is a diagram illustrating an example of transmission candidate positions of the SSB with SCS=120 kHz.

FIG. 5 is a diagram illustrating an example of transmission candidate positions of the SSB with SCS=240 kHz.

FIG. 6 is a diagram illustrating an example of a relation between an SCS and a symbol length.

FIG. 7 is a diagram illustrating an example of an SSB mapping pattern (symbol-level SSB mapping pattern) in a slot according to a second aspect.

FIG. 8 is a diagram illustrating another example of the SSB mapping pattern in the slot according to the second aspect.

FIG. 9 is a diagram illustrating an example of an SSB mapping pattern (slot-level SSB mapping pattern) in a half slot according to a third aspect.

FIG. 10 is a diagram illustrating another example of the SSB mapping pattern (slot-level SSB mapping pattern) in the half slot according to the third aspect.

FIG. 11 is a diagram illustrating an example of an SMTC window period according to a seventh aspect.

FIG. 12 is a diagram illustrating an example of a schematic configuration of a radio communication system according to one embodiment.

FIG. 13 is a diagram illustrating an example of a configuration of a base station according to one embodiment.

FIG. 14 is a diagram illustrating an example of a configuration of a user terminal according to one embodiment.

FIG. 15 is a diagram illustrating an example of a hardware configuration of a base station and a user terminal according to one embodiment.

### DESCRIPTION OF EMBODIMENTS

### (FR)

In NR, it has been studied to use a frequency band up to 52.6 GHz. In NR after Rel. 16, it is considered to use a frequency band higher than 52.6 GHz (above 52.6 GHz). Note that the frequency band may be appropriately referred to as a frequency range (FR).

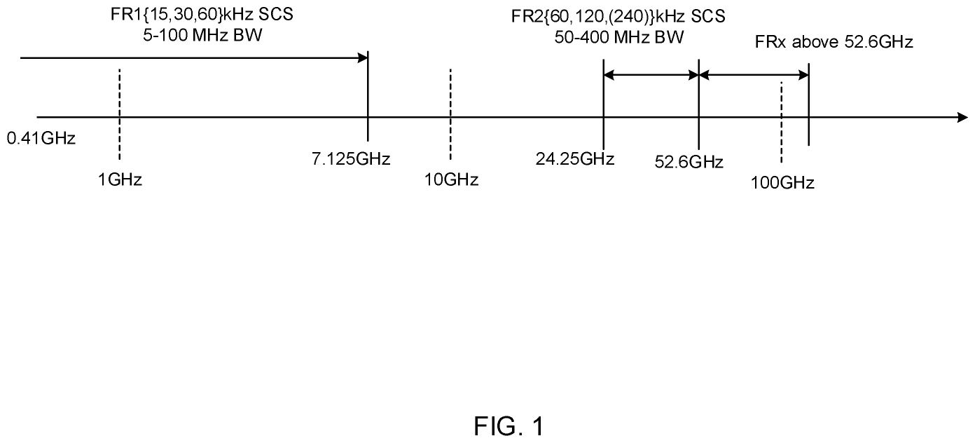

FIG. 1 is a diagram illustrating an example of FR. As illustrated in FIG. 1, a target FR (FRx (x is any character string)) is, for example, 52.6 GHz to 114.25 GHz. Note that as a frequency range in NR, FR1 is 410 MHz to 7.152 GHz, and FR2 is 24.25 GHz to 52.6 GHz.

### (SSB/SSB Burst Structure)

In NR, a synchronization signal/physical broadcast channel (SS/PBCH) block is used. The SS/PBCH block may be a signal block including a primary synchronization signal (PSS), a secondary synchronization signal (SSS), and a broadcast channel (physical broadcast channel (PBCH)) (and a demodulation reference signal (DMRS) for PBCH). The SS/PBCH block may be also referred to as a synchronization signal block (SSB).

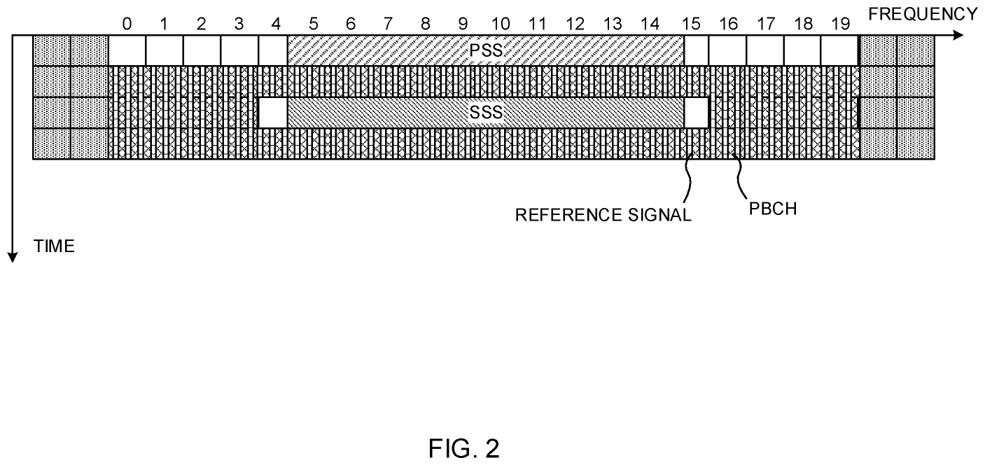

The SSB is composed of one or more symbols (for example, OFDM symbols). Specifically, the SSB may be composed of a plurality of consecutive symbols (for example, in FIG. 2, four symbols). Within the SSB, the PSS, the SSS, and the PBCH may be arranged (allocated) in one or more different symbols. For example, it is also considered that the SSB includes four or five symbols including a PSS of one symbol, an SSS of one symbol, and a PBCH of two or three symbols.

A collection of one or more SSBs may be referred to as an SSB burst. The SSB burst may be configured with consecutive SSBs in frequency and/or time resources, or may be configured with non-consecutive SSBs in frequency and/or time resources. The SSB burst may be set at a predetermined periodicity (which may be referred to as an SSB burst periodicity), or may be configured at an aperiodic period.

Further, one or more SSB bursts may be referred to as an SSB burst set (SSB burst series). The SSB burst set is configured periodically. The user terminal may control reception processing on the assumption that the SSB burst set is transmitted periodically (with an SSB burst set periodicity (SS burst set periodicity)).

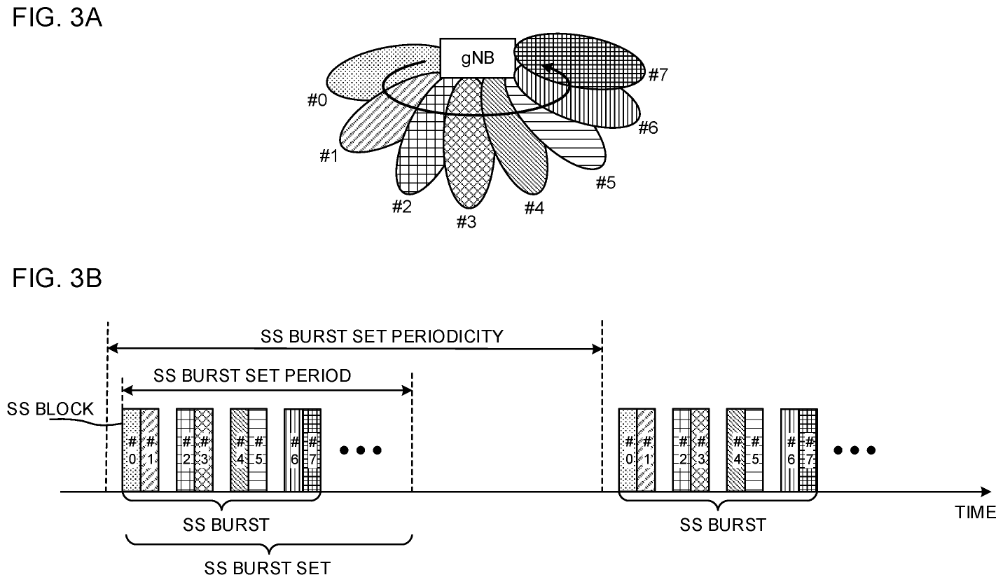

FIG. 3A illustrates an example of beam sweeping. As illustrated in FIG. 3A, a base station (for example, gNB) may make directivities of beams different in time (beam sweeping), and transmit different SS blocks using different beams. Note that an example using multiple beams is illustrated in FIGS. 3A and 3B, but it is also possible to transmit the SS block using a single beam.

As illustrated in FIG. 3B, an SS burst is composed of one or more SS blocks, and an SS burst set is composed of one or more SS bursts. For example, in FIG. 3B, it is assumed that the SS burst is constituted by eight SS blocks #0 to #7, but the present invention is not limited thereto. The SS blocks #0 to #7 may be transmitted by different beams #0 to #7 (FIG. 3A), respectively.

As illustrated in FIG. 3B, the SS burst set including the SS blocks #0 to #7 may be transmitted so as not to exceed a predetermined period (for example, 5 ms or less, also referred to as an SS burst set period or the like). Further, the SS burst set may be repeated at given periodicity (for example, 5, 10, 20, 40, 80, or 160 ms, also referred to as an SS burst set periodicity, an SSB transmission periodicity, or the like).

Further, an index (SS block index) of the SS block is notified using the PBCH and/or the DMRS (demodulation reference signal) for PBCH (PBCH DMRS) included in the SS block. The UE can grasp the SS block index of the received SS block based on the PBCH (or PBCH DMRS).

Master information block (MIB) of minimum system information (MSI) read by the UE at the time of the initial access is carried by the PBCH. The remaining MSI is remaining minimum system information (RMSI), and corresponds to system information block (SIB) 1, SIB2, or the like in LTE. Further, the RMSI is scheduled by the PDCCH indicated by the MIB.

In NR, the SS block (SSB) may be used for synchronization, cell detection, timing detection of a frame and/or a slot, and the like. A plurality of SSBs within an SSB transmission period of 5 ms may indicate the same cell ID. Each SSB may be identified with an SSB index. The SSB index may be used for determining the SSB time position (transmission candidate position) within the SSB transmission period.

The maximum number L of SSB that can be transmitted within one SSB transmission periodicity may be determined according to the FR described above. For example, L in FR1 described above may be 8, and L in FR2 described above may be 64. The SSB transmission periodicity may be configured to one of 5, 10, 20, 40, 80, and 160 ms.

One SSB transmission periodicity is included in the SSB transmission periodicity. The transmission candidate positions (timings, time resources) of the SSB within the SSB transmission period (for example, 5 ms) may be defined by specifications. The SSB transmission period may be a 5 ms half frame of the first half or the second half of a radio frame. For example, 64 SSB transmission candidate positions may be defined for a frequency band of 6 GHz or higher and a subcarrier spacing (SCS, numerology) of 120 kHz.

The transmission candidate position of the SSB may be represented by an SSB index in a time direction.

The base station (network, gNB) may transmit an arbitrary number of SSBs of L or less in each SSB transmission periodicity. The base station may notify the UE of information (also referred to as SSB position information, intra-burst SSB position information, and the like) indicating an SSB (actually transmitted SSB, actual transmission SSB) to be actually transmitted. The information may be, for example, a bitmap. Furthermore, the SSB position information may be, for example, “ssb-PositionsInBurst” of RRC IE.

The UE is only required to be able to detect one SSB in synchronization, cell detection, timing detection of a frame and/or a slot, and the like. Meanwhile, the UE can perform rate matching, measurement, or the like with high accuracy by recognizing the actually transmitted SSB by the SSB position information in the rate matching, the measurement, or the like.

The SSB position information may include bits for each transmission candidate position of the actual transmission SSB, and each bit may indicate whether or not the corresponding SSB is transmitted. For example, in FR1, an 8-bit bitmap notified using at least one of RRC signaling or SIB1 may be used. In FR2, a 64 bit bitmap notified by using RRC signaling, an 8-bit bitmap for SSB in a predetermined group, or an 8-bit group bitmap in the SIB1 may be used.

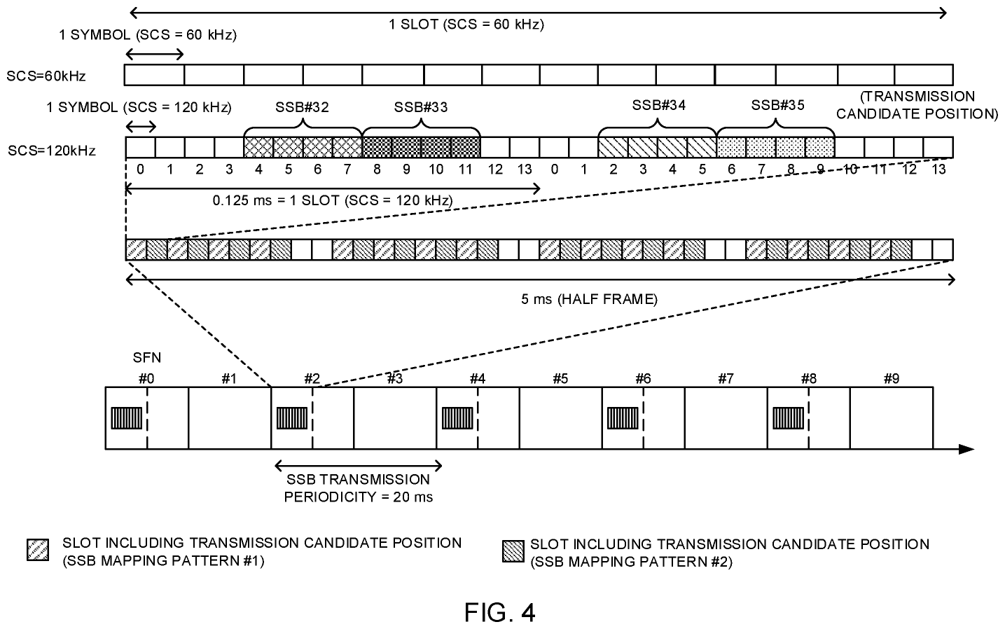

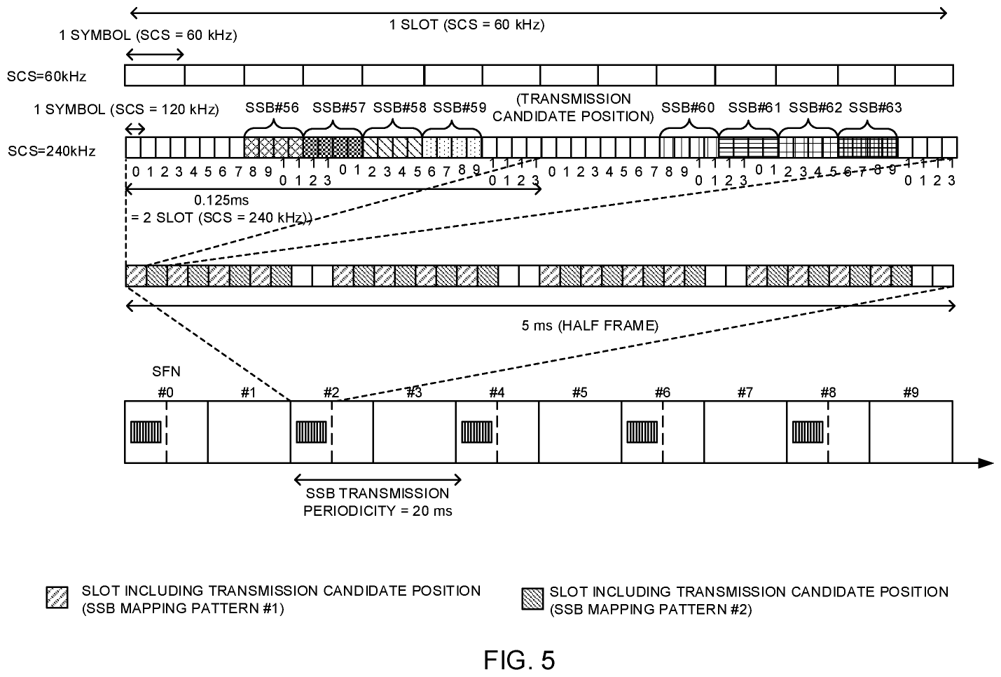

FIGS. 4 and 5 are diagrams illustrating examples of transmission candidate positions of the SSB in a case where a subcarrier spacing (SCS) of 120 kHz and 240 kHz and an SSB transmission periodicity of 20 ms are used. Note that the SSB transmission periodicity is not limited to 20 ms.

Corresponding to the FR and the SCS, 64 transmission candidate positions within the SSB transmission period (5 ms) may be defined by the specifications. In this example, among 10 slots in one radio frame (1 ms), the first eight slots include the transmission candidate positions, and the last two slots do not include the transmission candidate positions. These two slots are secured for use in UL or the like. Each slot of the first eight slots includes two transmission candidate positions. The length of one transmission candidate position is four symbols. Note that the SSB transmission period (5 ms) may be provided in a half frame (for example, in FIGS. 4 and 5, the first half frame) in one radio frame, but is not limited to that illustrated.

As illustrated in FIGS. 4 and 5, the same SSB mapping pattern may be used or different SSB mapping patterns may be used in the slots including the transmission candidate positions in the half frame (SSB transmission period). For example, FIG. 4 illustrates a slot to which the SSB mapping pattern #1 including the SSBs #32 and #33 is applied and a slot to which the SSB mapping pattern #2 including the SSBs #34 and #35 is applied.

Further, in the case of the SCS of 240 kHz illustrated in FIG. 5, since the number of slots included in the half frame increases, more SSBs than in FIG. 4 may be included in 0 and 125 ms.

### (SSB-Based Measurement)

The UE may receive information regarding SSB-based measurement (SS/PBCH block based measurement timing configuration (SMTC) information). The SMTC information may be, for example, an information element (IE) included in a measurement indication (for example, the measurement object) notified to a connected UE (connected UE) by RRC signaling.

The SMTC information may include information (SMTC window information) indicating a predetermined window (SMTC window) used for measurement using the SSB. The SMTC window information may include at least one of a period (for example, 5, 10, 20, 40, 80, or 160 ms), an offset (for example, granularity of 1 ms), and a duration (for example, 1, 2, 3, 4, or 5 ms) of the SMTC window.

Furthermore, the SMTC information may include information (SSB information for measurement, for example, “SSB-ToMeasure” of RRC IE) indicating an SSB (SSB index) for measurement. The SSB information for measurement may be, for example, an 8-bit bitmap in FR1 and a 64 bit bitmap in FR2. The measurement SSB information may indicate not only the serving cell but also the actual transmission SSB of the peripheral cell using the same frequency.

Incidentally, in FRx (also referred to as a predetermined frequency range or the like) which is a frequency band higher than 52.6 GHz, it is assumed that phase noise increases, propagation loss increases, and high sensitivity is provided for at least one of a peak-to-average power ratio (PAPR) and a PA having non-linearity. Thus, in FRx, it is studied to use at least one waveform of CP-OFDM and DFT-S-OFDM with a larger SCS.

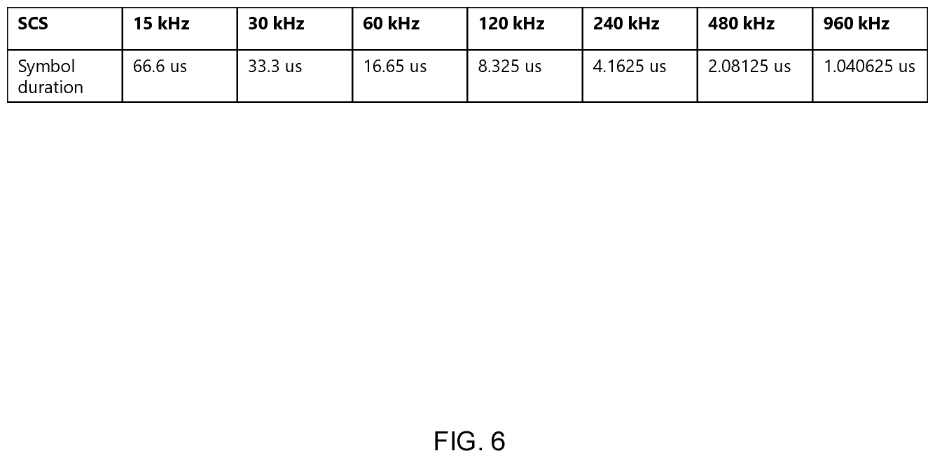

On the other hand, since the SCS and the symbol length have a reciprocal relation, when the SCS is increased, at least one of the symbol length (also referred to as a symbol period) and the cyclic prefix (CP) length is shortened (for example, FIG. 6). Further, in a case where the number of symbols in the slot is the same (for example, maintained to 14 symbols), when the SCS is increased, the slot duration is also shortened. The time domain duration of the SSB (four symbols) is also shortened.

Furthermore, in the FRx described above, it is assumed that a narrower beam based on an antenna (massive antenna) having massive elements is used for a wide band and a large propagation loss. Thus, in order to cover a certain area, it is assumed that a larger number of beams are required as compared with a case where a wider beam is used.

In FR2 of NR in Rel. 15, a maximum number of SSBs (see, for example, FIG. 3A) transmitted in different beams is 64. On the other hand, as described above, in FRx, when an area in the same range as FR2 is to be covered, it is desirable that the SSB can be transmitted with more than 64 beams. Such problems may arise not only for FRx higher than 52.6 GHz but also for FR1, 2.

Accordingly, the present inventors have conceived to apply at least one of the following in FRx that is a frequency band higher than 52.6 GHz.
Extending the range of the SSB index beyond 0 to 63 (first aspect)
Changing the mapping pattern (SSB mapping pattern) of the SSB in the slot from Rel. 15 NR (second aspect)
Changing the SSB mapping pattern (the pattern of the slot including the SSB candidate positions) in the half-frame from Rel. 15 NR (third aspect)
Changing indication of actually transmitted SSB index from Rel. 15 NR (fourth aspect)
Changing the number of beams for the SSB monitored by the UE (fifth aspect)
Changing the number of beams for the SSB on which the UE performs measurement (sixth aspect)
Introducing a configuration of a new SMTC window (seventh aspect)
Introducing a configuration of a new measurement gap (eighth aspect)

Hereinafter, embodiments according to the present disclosure will be described in detail with reference to the drawings. Note that the following first to seventh aspects may be used alone, or may be applied by combining at least two of them.

Note that the present embodiment may be applied not only to the FRx (for example, the predetermined frequency range higher than 52.6 GHz) but also to existing FR1 and FR2.

Further, an example in which the SCS is 120 kHz will be mainly described below, but the present embodiment can also be applied to an SCS (for example, 240 kHz, 480 kHz, or 960 kHz) larger than 120 kHz and an SCS (for example, 60 kHz, 30 kHz, or 14 kHz) smaller than 120 kHz.

### (First Aspect)

In the first aspect, the range of the SSB index may be extended over the existing range (0 to 63), for example, 0 to 255.

In this case, the maximum number L of SSBs that can be transmitted within the SSB transmission periodicity may be greater than 64, for example, may be 256. This number may be determined. For example, L in FR1 described above may be 8, and L in FR2 described above may be 64. The SSB transmission periodicity may be configured to one of 5, 10, 20, 40, 80, and 160 ms, or a period longer than 160 ms may be supported.

According to the first aspect, because different SSB indexes correspond to different beams, by extending the range of the SSB index, the coverage area of the SSB can be maintained even when narrower beams than those of the massive antenna are used.

### (Second Aspect)

In the SSB mapping pattern in the slot of Rel. 15 NR, a plurality of SSBs is successively arranged (allocated) as indicated by SSBs #32 and #33 and SSBs #34 and #35 in FIG. 4 and SSBs #56 to #59 and SSBs #60 to #61 in FIG. 5.

On the other hand, in the SSB mapping pattern in the slot according to the second aspect, a predetermined period (also referred to as a symbol gap, a gap period, and the like) for a gap of one or more symbols may be provided between different SSBs. One or a plurality of SSBs may be arranged (allocated) together with the symbol gap in one slot. The symbol gap may be referred to as a non-transmission period or the like of the symbol-level SSB.

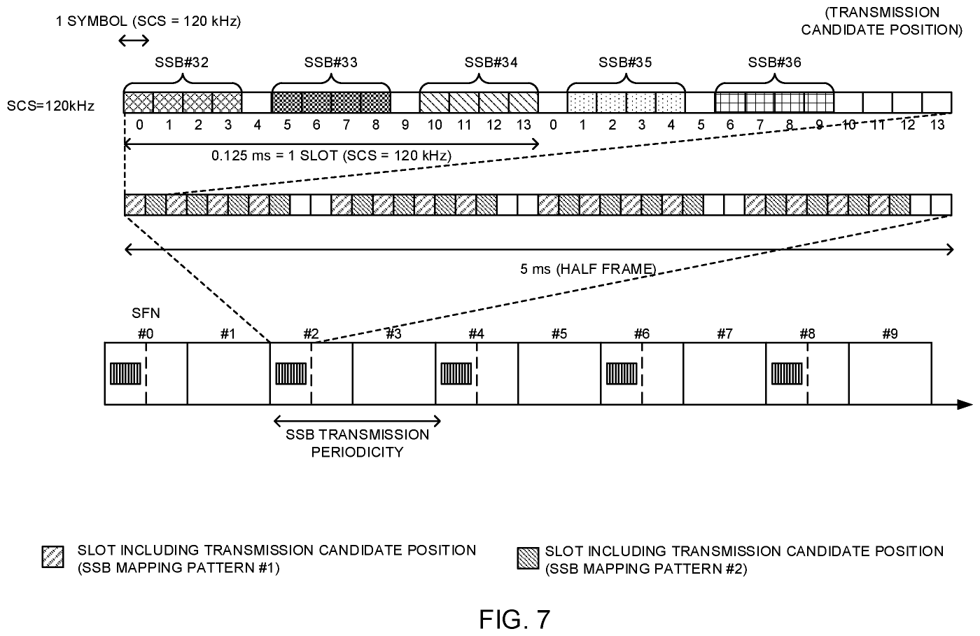

FIG. 7 is a diagram illustrating an example of the SSB mapping pattern (symbol-level SSB mapping pattern) in the slot according to the second aspect. As illustrated in FIG. 7, one or more SSBs may be arranged (allocated) in each slot including the transmission candidate position. Further, one or more symbol gaps may be provided between the plurality of SSBs.

Note that the SSB mapping pattern illustrated in FIG. 7 is merely an example, and the SSB mapping pattern is not limited thereto. Further, as described in the third aspect, an arrangement pattern of slots including the transmission candidate positions in the half frame (a slot-level SSB mapping pattern to be described later) is not limited to that illustrated in FIG. 7.

For example, in the SSB mapping pattern #1 of FIG. 7, a symbol gap of one symbol is provided between three SSBs #32, #33, and #34 in the slot. Further, in the SSB mapping pattern #2, a symbol gap of one symbol is provided between the two SSBs #35 and #36 in the slot. Furthermore, as illustrated in FIG. 7, when slots including the transmission candidate positions are consecutive slots, the SSB mapping patterns #1 and #2 may be determined such that symbol gaps (for example, symbol #0) are also provided between SSBs (for example, in FIG. 7, SSBs #34 and #35) arranged (allocated) in different slots.

In this way, by providing symbol gaps between SSBs of different SSB indexes, beam switching delays can be covered.

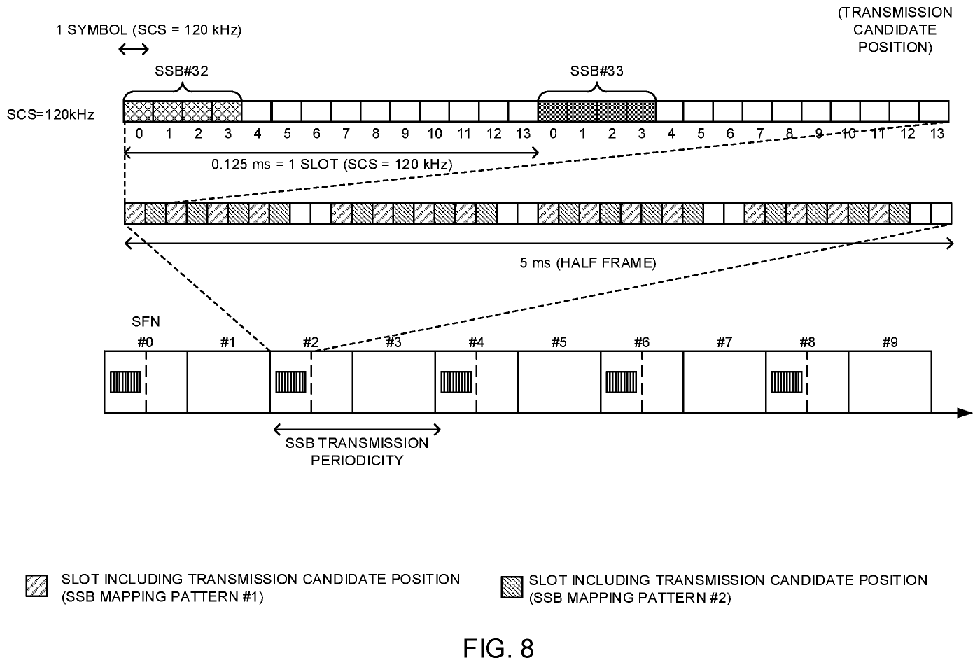

FIG. 8 is a diagram illustrating another example of the SSB mapping pattern in the slot according to the second aspect. As illustrated in FIG. 8, one SSB may be allocated in each slot including the transmission candidate position. That is, FIG. 8 is different from FIG. 7 in that only one SSB is transmitted in the slot. A difference from FIG. 7 will be mainly described in FIG. 8.

As illustrated in FIG. 8, by transmitting a single SSB within a slot, symbols unused for the SSB (for example, in FIG. 8, symbols #4 to #13) can be used for other signals (for example, PDSCH or PUSCH), and thus multiplexing of the SSB and data can be facilitated.

Note that, in FIG. 8, the SSB is allocated in a first predetermined number of symbols (here, four symbols) of the slot, but the arrangement symbol of the SSB in the slot is not limited thereto. For example, the SSB may be allocated in a last predetermined number of symbols in the slot, or the SSB may be allocated in the predetermined number of symbols at the center in the slot. By arranging the SSB in a predetermined number of symbols at the end or center of the slot, it is possible to avoid collision with at least one of a control resource set (CORESET), a reference signal (RS), and the like.

### (Third Aspect)

In the SSB mapping pattern in the half frame (5 ms) of Rel. 15 NR, slots including the SSB (or transmission candidate positions) may be consecutively allocated, as illustrated in FIGS. 4 and 5. For example, in FIGS. 4 and 5, SSBs (or SSB transmission candidate positions) are allocated in eight consecutive slots, and two slots are gap periods.

On the other hand, in the SSB mapping pattern in the half frame according to the third aspect, at least a part of the slots including the SSB (or the transmission candidate position) may be discontinuously allocated by a predetermined period (also referred to as a slot gap, a gap period, and the like) for the gap of one or more slots. The slot gap may be referred to as a non-transmission period or the like of the slot-level SSB.

Specifically, all the slots including the SSB (or the transmission candidate position) may be discontinuously allocated by using a slot gap (first slot gap), or a predetermined number X of slots including the SSB (or the transmission candidate position) may be continuous, and a slot gap may be provided between sets of the X slots (second slot gap).

### <First Slot Gap>

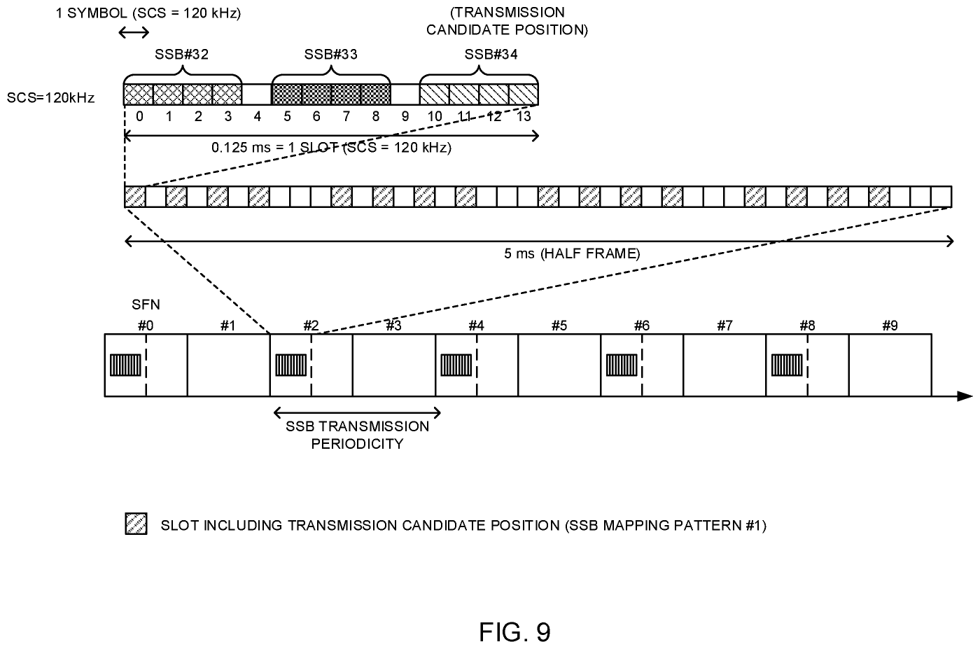

FIG. 9 is a diagram illustrating an example of an SSB mapping pattern (slot-level SSB mapping pattern) in the half slot according to the third aspect. As illustrated in FIG. 9, in the half slot, a plurality of slots each including a transmission candidate position may be separated by a slot gap of one or more slots.

Note that the SSB mapping pattern in one slot illustrated in FIG. 9 is merely an example and is not limited thereto. Further, as described in the second aspect, the symbol-level SSB mapping pattern is not limited to that illustrated in FIG. 9. Furthermore, in FIG. 9, only the slot to which the SSB mapping pattern #1 at the symbol level is applied is illustrated, but a slot to which another SSB mapping pattern (for example, SSB mapping pattern #2 in FIG. 7) is applied may be provided.

For example, in FIG. 9, slots including transmission candidate positions are allocated using a slot gap of one slot or three slots in a 5-ms half frame. In FIG. 9, a plurality of slots each including a transmission candidate position is different from that of Rel. 15 NR (for example, FIGS. 4 and 5) in that the slots are not continuous. As the slot gap is made longer, the slots available for data (for example, PUSCH or PDSCH) increase, and thus the restriction on scheduling by the SSB can be reduced.

### <Second Slot Gap>

In FIGS. 7 and 8, a predetermined number X (for example, in FIGS. 7 and 8, X=8) of slots including SSB (or transmission candidate positions) is continuous and a slot gap is provided between sets of the X slots, but the value of X is not limited to 8.

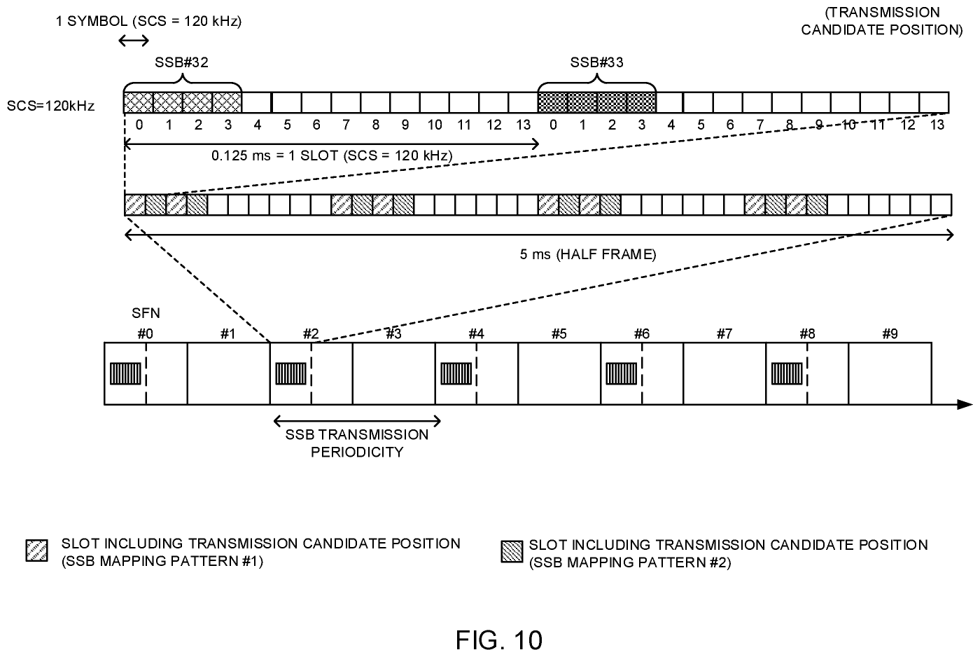

FIG. 10 is a diagram illustrating an example of an SSB mapping pattern (slot-level SSB mapping pattern) in the half slot according to the third aspect. For example, in FIG. 10, X =4. In FIG. 10, a slot gap of six slots is provided between sets of four slots including the SSB (or the transmission candidate position).

As illustrated in FIG. 10, as the value of X decreases, the slots available for data (for example, PUSCH or PDSCH) increases, and thus the restriction on scheduling by the SSB can be reduced. Further, as illustrated in FIG. 10, by reducing the number of SSBs in the slot including the transmission candidate positions, multiplexing of data and SSBs can be further promoted.

On the other hand, although not illustrated, the value of X may be larger than 8. As the number of consecutive slots X that include the SSB (or transmission candidate position) increases, the slot gaps included within a measurement period (SMTC window) of the SSB can be decreased. Therefore, as the number of consecutive times X is increased, the measurement period can be reduced.

### (Fourth Aspect)

As described in the first aspect, when extending the range of the SSB index beyond 0 to 63, it is assumed that the information (“ssb-PositionsInBurst” of the RRC IE, for example, also referred to as SSB position information, intra-burst SSB position information, or the like) indicating the actually transmitted SSB (actual transmission SSB) is also extended.

The SSB position information may be, for example, a bitmap (for example, a 256 bit bitmap) equal to (1) the range of the extended SSB index (for example, 0 to 256) (the maximum number of SSBs transmitted within the SSB transmission periodicity).

Alternatively, the SSB position information may be, for example, a combination of (2) a group bitmap (groupPresence) and an intra-group bitmap (InOneGroup, bitmap in group). The group bitmap may indicate whether or not the SSB is transmitted in each group within the SSB transmission period. The intra-group bitmap may indicate whether the SSB is transmitted at each transmission candidate position (or slot including the transmission candidate position) in the group.

Alternatively, the SSB position information may be, for example, (3) the group bitmap (groupPresence). In (3), signaling overheads can be reduced as compared with (2).

Note that the SSB position information may be notified to the UE by higher layer signaling. Here, the higher layer signaling is only required to be, for example, at least one of radio resource control (RRC) signaling, broadcast information (master information block (MIB), system information block (SIB), or the like), or medium access control (MAC) signaling.

### (Fifth Aspect)

In NR Rel. 15, reference signals (or an index of the reference signal, for example an SSB index or a CSI-RS index) up to a predetermined number N_{LR_RLM} used for at least one of link recovery and radio link monitoring (RLM) are configured in the UE based on the maximum number L_{MAX} of SSBs per half frame. Further, reference signals up to a predetermined number N_{RLM} among the reference signals of the predetermined number N_{LR_RLM} may be used for RLM according to the maximum number L_{MAX} of candidate SSBs per half frame. Further, the two reference signals may be used in the link recovery procedure. For example, in the following Table 1, values of N_{LR_RLM} and N_{RLM} for different values of L_{MAX} are illustrated.

TABLE 1

| Lₘₐₓ | N_{LR-RLM} | N_{RLM} |
|---|---|---|
| 4 | 2 | 2 |
| 8 | 6 | 4 |
| 64 | 8 | 8 |

When the range of the SSB index is extended as described in the first aspect, it is assumed that the maximum number L_{MAX} of SSBs per half frame is greater than 64. Thus, in the fifth aspect, the values of N_{LR_RLM} and N_{RLM} in L_{MAX}>64 (for example, 256) will be described.

In a case of (1) L_{MAX}>64 (for example, 256), N_{LR_RLM}>8 (for example, 32) and N_{RLM} >8 (for example, 32) may be satisfied. In this case, robustness for mobility of the UE can be improved. This is because it is not necessary to reconfigure the reference signal for RLM frequently.

Alternatively, in a case of (2) L_{MAX}>64 (for example, 256), above-described N_{LR_RLM}>8 (for example, 32) and N_{RLM}<8 (for example, 4) may be satisfied.

Alternatively, in a case of (3) L_{MAX}>64 (for example, 256), the UE does not need to be provided with the SSB as the reference signal for RLM. In this case, the UE may monitor the CSI-RS as a state (TCI state) of an active transmission configuration identifier (transmission configuration indicator (TCI)) of the PDCCH. Thus, it is possible to relax UE load (effort) such as UE complexity and power consumption.

### (Sixth Aspect)

In NR Rel. 15, in each intra-frequency layer, during each Layer 1 measurement period, the UE can perform measurement using SSB on at least 6 identified cells and 24 SSBs having at least one of different SSB indexes and physical cell IDs (PCI). Here, the measurement using the SSB may include measurement of at least one of SS-RSRP, SS-RSRQ, or SS-SINR.

In the sixth aspect, in the frequency band higher than 52.6 GHz (for example, FRx), the UE may perform measurement using the SSB on at least a predetermined number of SSBs having at least one of different SSB indexes and PCIs.

The predetermined number of SSBs may be a number of SSBs greater than 24, which is a threshold value of SSBs for measurement in NR Rel. 15. Thus, the base station can obtain more information in a measurement report.

Alternatively, the predetermined number of SSBs may be a number of SSBs equal to or less than 24 which is a threshold value of the SSB for measurement of NR Rel. 15. Thus, it is possible to relax UE load (effort) such as UE complexity and power consumption.

### (Seventh Aspect)

In the seventh aspect, a configuration of a new SMTC window will be described.

### <SMTC Window Period>

In NR Rel. 15, for example, 1, 2, 3, 4, and 5 ms are supported as the value of the period (SMTC window period) of the SMTC window. In the seventh aspect, a new value (candidate value) of the SMTC window period may be introduced. Alternatively, the new value (candidate value) of the SMTC window period may be limited more than by NR Rel. 15.

For example, a value smaller than 1 ms may be introduced as the new value (candidate value) of the SMTC window period. That is, granularity of the SMTC window period may be smaller than 1 ms.

In addition, the maximum value of the SMTC window period may be smaller than 5 ms. As described above, by shortening the SMTC window period, it is possible to relax UE load (effort) such as UE complexity and power consumption.

In NRx, since it is assumed that a wide SCS such as 120 kHz or 240 kHz is used, the symbol length becomes short. Consequently, when the slot is configured with the same 14 symbols, the slot length is also shortened, and thus a value smaller than the existing value may be supported as the value of the SMTC window period.

### <SMTC Window Set>

Further, in the configuration of the new SMTC window, a set (SMTC window set) including a plurality of SMTC windows may be configured in the UE at given periodicity. A gap period may be allocated between the plurality of SMTC windows in the SMTC window set.

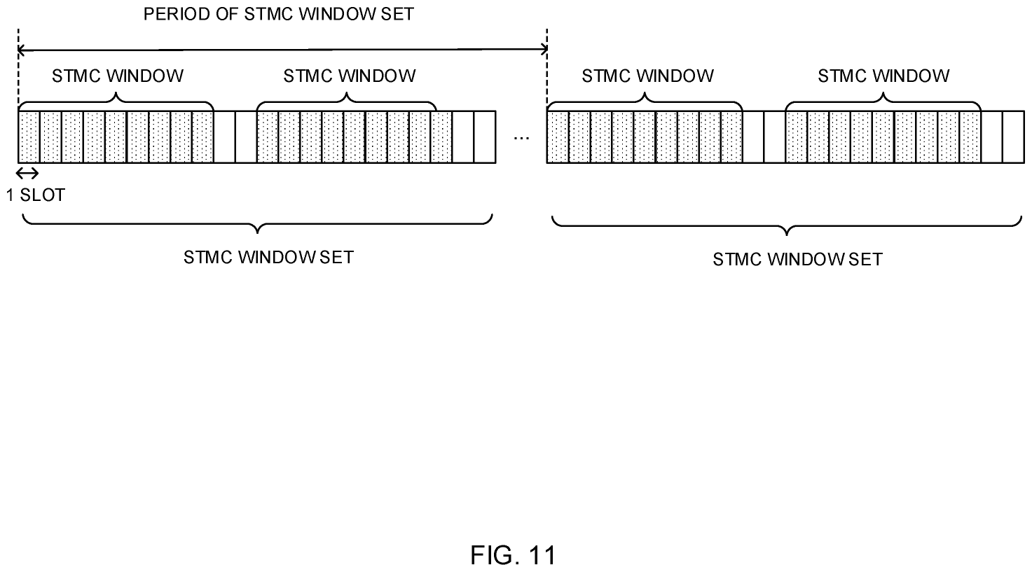

FIG. 11 is a diagram illustrating an example of the SMTC window period according to the seventh aspect. In FIG. 11, for example, the SMTC window may include eight consecutive slots. In FIG. 11, the plurality of SMTC windows (here, for example, two SMTC windows) in the SMTC window set are allocated discontinuously with a predetermined number of gap periods.

As illustrated in FIG. 11, in the new SMTC window configuration, SMTC window sets may be allocated at given periodicity instead of arranging the SMTC windows at given periodicity. The period of the SMTC window sets may be configured in the UE by a higher layer parameter.

### <Period/Offset of SMTC Window>

In NR Rel. 15, 5, 10, 20, 40, 80, and 160 ms are supported as the period of the SMTC window. In addition, the granularity of the offset of the SMTC window is 1 ms.

In the seventh aspect, a new value (candidate value) of at least one (period/offset) of the period and the offset of the SMTC window may be introduced.

For example, an offset granularity of the SMTC window (or the SMTC window set) may be smaller than 1 ms. Thus, the flexibility of timing of the SMTC window and the measurement period can be shortened, and the load on the UE can be reduced.

Further, the period of the SMTC window (or the SMTC window set) may support a value larger than 160 ms (for example, 320 ms). This can reduce measurement-based SSB overhead assuming mobility below 52.6 GHz.

### (Eighth Aspect)

In the eighth aspect, a configuration of a new measurement gap for different frequency measurement (inter-frequency measurement) will be described.

A measurement gap of (shorter or finer) granularity shorter than that of Rel. 15 may be introduced. This can reduce overhead for different frequency measurement.

Repetition values of longer gaps than that of Rel. 15 (for example, 160 ms) may be introduced. This can reduce overhead for different frequency measurement.

Gap offsets of a smaller granularity than Rel. 15 (for example, 1 ms) may be introduced. Thus, flexibility of the gap timing can be facilitated, and overhead for different frequency measurement can be reduced.

Smaller gap timing advance values less than that of Rel. 15 (for example, 0.25 ms) may be supported. Thus, flexibility of the gap timing can be facilitated, and overhead for different frequency measurement can be reduced.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

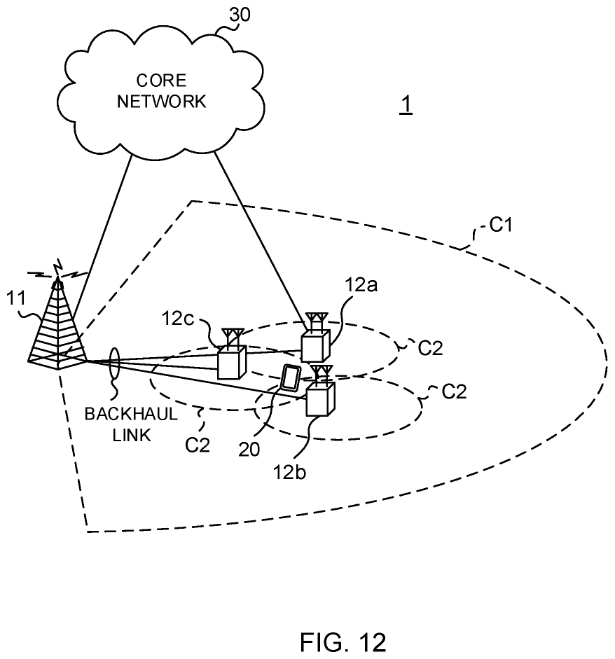

FIG. 12 is a diagram illustrating an example of a schematic configuration of a radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In EN-DC, an LTE (E-UTRA) base station (eNB) is a master node (MN), and an NR base station (gNB) is a secondary node (SN). In NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNBs) (NR-NR dual connectivity (NN-DC)).

The radio communication system 1 may include a base station 11 that forms a macro cell C1 with a relatively wide coverage, and base stations 12 (12a to 12c) that are arranged in the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as base stations 10 unless specified otherwise.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range 1 (FR1) and a second frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of FR1 and FR2 are not limited to these, and for example, FR1 may be a frequency range higher than FR2.

Further, the user terminal 20 may perform communication on each CC using at least one of time division duplex (TDD) or frequency division duplex (FDD).

The plurality of base stations 10 may be connected by wire (for example, an optical fiber or an X2 interface in compliance with common public radio interface (CPRI)) or by radio (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

A base station 10 may be connected to a core network 30 via another base station 10 or directly. The core network 30 may include, for example, at least one of evolved packet core (EPC), 5G core network (5GCN), next generation core (NGC), and the like.

The user terminal 20 may be a terminal corresponding to at least one of communication methods such as LTE, LTE-A A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that, in the radio communication system 1, another radio access method (for example, another single carrier transmission method and another multi-carrier transmission method) may be used as UL and DL radio access methods.

In the radio communication system 1, as a downlink channel, a physical downlink shared channel (PDSCH) shared by each user terminal 20, a physical broadcast channel (PBCH), a physical downlink control channel (PDCCH), or the like may be used.

In the radio communication system 1, an uplink shared channel (physical uplink shared channel (PUSCH)) shared by each user terminal 20, an uplink control channel (physical uplink control channel (PUCCH)), a random access channel (physical random access channel (PRACH)), and the like may be used as uplink channels.

User data, higher layer control information, and a system information block (SIB) and the like are transmitted by the PDSCH. The PUSCH may transmit user data, higher layer control information, and the like. Further, the PBCH may transmit a master information block (MIB).

Lower layer control information may be transmitted by PDCCH. The lower layer control information may include, for example, downlink control information (DCI) including scheduling information of at least one of the PDSCH and the PUSCH.

Note that, the DCI for scheduling the PDSCH may be referred to as DL assignment, DL DCI, and the like, and the DCI for scheduling the PUSCH may be referred to as UL grant, UL DCI, and the like. Note that PDSCH may be replaced with DL data, and PUSCH may be replaced with UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or a plurality of search spaces. The UE may monitor CORESET associated with a certain search space based on search space configuration.

One search space may correspond to a PDCCH candidate corresponding to one or more aggregation levels. One or a plurality of search spaces may be referred to as a search space set. Note that “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), or the like may be transmitted on the PUCCH. A random access preamble for establishing a connection with a cell may be transmitted on PRACH.

Note that in the present disclosure, downlink, uplink, and the like may be expressed without “link”. Furthermore, various channels may be expressed without “physical” at the beginning thereof.

In the radio communication system 1, a synchronization signal (SS), a downlink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as the DL-RS.

The synchronization signal may be at least one of, for example, a primary synchronization signal (PSS) and a secondary synchronization signal (SSS). A signal block including SS (PSS or SSS) and PBCH (and DMRS for PBCH) may be referred to as an SSB, an SS Block (SSB), and the like. Note that the SS, the SSB, or the like may also be referred to as a reference signal.

In the radio communication system 1, a sounding reference signal (SRS), a demodulation reference signal (DMRS), and the like may be transmitted as an uplink reference signal (UL-RS). Note that, DMRSs may be referred to as “user terminal-specific reference signals (UE-specific Reference Signals)”.

### (Base Station)

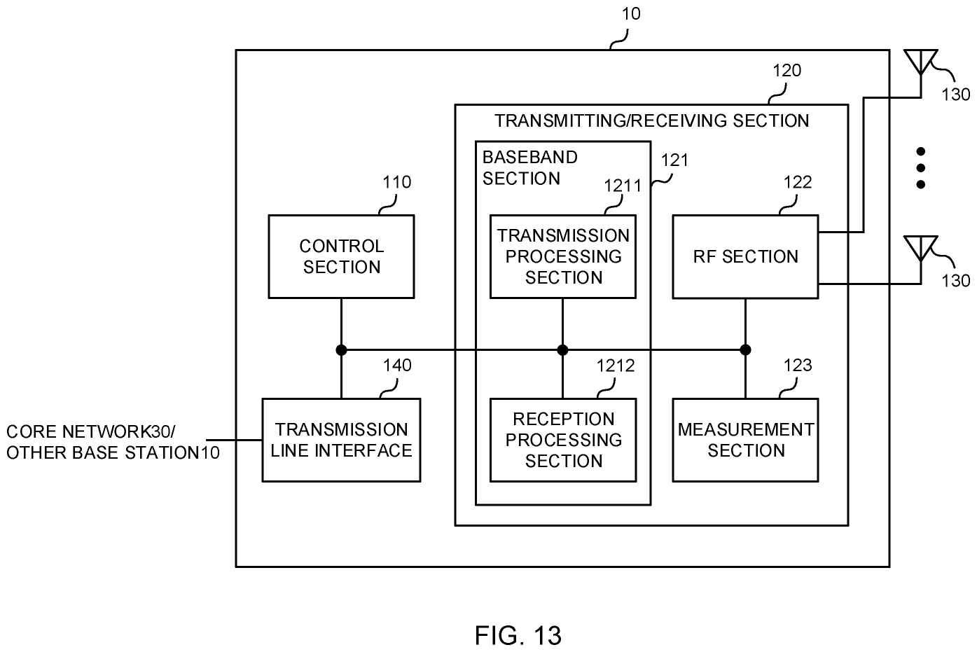

FIG. 13 is a diagram illustrating an example of a configuration of a base station according to one embodiment. The base station 10 includes a control section 110, a transmitting/receiving section 120, a transmission/reception antenna 130, and a transmission line interface 140. Note that one or more of the control sections 110, one or more of the transmitting/receiving sections 120, one or more of the transmission/reception antennas 130, and one or more of the transmission line interfaces 140 may be provided.

Note that, although this example will primarily illustrate functional blocks that pertain to characteristic parts of the present embodiment, it may be assumed that the base station 10 has other functional blocks that are necessary for radio communication as well. A part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like using the transmitting/receiving section 120, the transmission/reception antenna 130, and the transmission line interface 140. The control section 110 may generate data to be forwarded as a signal, control information, a sequence, and the like, and may transfer the data, the control information, the sequence, and the like to the transmitting/receiving section 120. The control section 110 may perform call processing (such as configuration or release) of a communication channel, management of the state of the base station 10, and management of a radio resource.

The transmitting/receiving section 120 may include a base band section 121, a radio frequency (RF) section 122, and a measurement section 123. The base band section 121 may include a transmission processing section 1211 and a reception processing section 1212. The transmitting/receiving section 120 can be implemented by a transmitter/receiver, an RF circuit, a base band circuit, a filter, a phase shifter, a measurement circuit, a transmission/reception circuit, and the like, which are described based on common recognition in the technical field related to the present disclosure.

The transmitting/receiving section 120 may be constituted as an integrated transmitting/receiving section, or may be constituted by a transmitting section and a receiving section. The transmitting section may be configured by the transmission processing section 1211 and the RF section 122. The receiving section may be constituted by the reception processing section 1212, the RF section 122, and the measurement section 123.

The transmission/reception antenna 130 can be implemented by an antenna described based on common recognition in the technical field related to the present disclosure, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a transmission beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, for example, on data or control information acquired from the control section 110 to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog transform on the bit string to be transmitted, and may output a base band signal.

The transmitting/receiving section 120 (RF section 122) may perform modulation to a radio frequency range, filtering processing, amplification, and the like on the base band signal, to transmit a signal in the radio frequency range via the transmission/reception antenna 130.

Meanwhile, the transmitting/receiving section 120 (RF section 122) may perform amplification, filtering processing, demodulation to a base band signal, and the like on the signal in the radio frequency band received by the transmission/reception antenna 130.

The transmitting/receiving section 120 (reception processing section 1212) may apply reception processing such as analog-digital transform, fast Fourier transform (FFT) processing, inverse discrete Fourier transform (IDFT) processing (if necessary), filtering processing, demapping, demodulation, decoding (which may include error correction decoding), MAC layer processing, RLC layer processing, and PDCP layer processing on the acquired base band signal to acquire user data and the like.

The transmitting/receiving section 120 (measurement section 123) may perform measurement on the received signal. For example, the measurement section 123 may perform radio resource management (RRM) measurement, channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), or a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, other base stations 10, and the like, and may acquire, transmit, and the like user data (user plane data), control plane data, and the like for the user terminal 20.

Note that the transmitting section and the receiving section of the base station 10 in the present disclosure may include at least one of the transmitting/receiving section 120, the transmission/reception antenna 130, and the transmission line interface 140.

Note that the transmitting/receiving section 120 may transmit the SMTC information to the user terminal 20. The transmitting/receiving section 120 may transmit the SSB.

### (User Terminal)

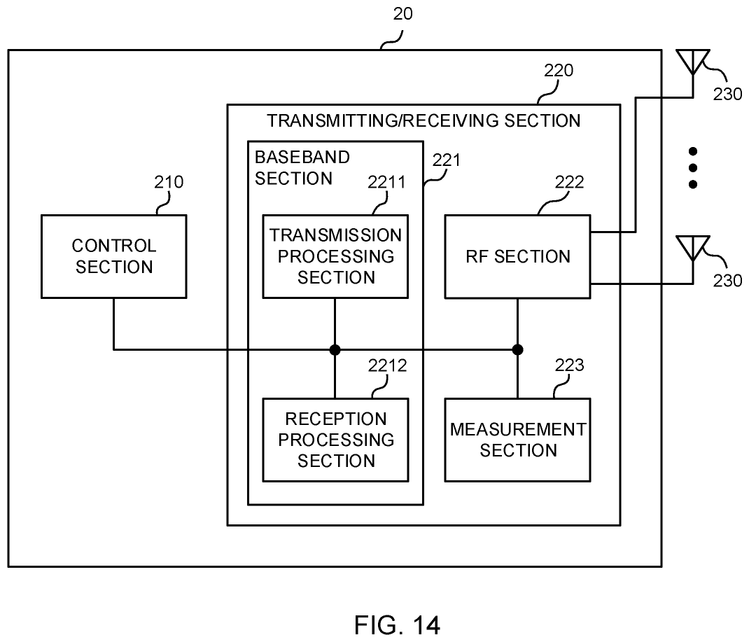

FIG. 14 is a diagram illustrating an example of a configuration of a user terminal according to one embodiment. The user terminal 20 includes a control section 210, a transmitting/receiving section 220, and a transmission/reception antenna 230. Note that one or more of the control sections 210, one or more of the transmitting/receiving sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can be constituted by a controller, and a control circuit, which are described based on common recognition in the technical field according to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a base band section 221, an RF section 222, and a measurement section 223. The base band section 221 may include a transmission processing section 2211 and a reception processing section 2212. The transmitting/receiving section 220 can include a transmitter/receiver, an RF circuit, a base band circuit, a filter, a phase shifter, a measurement circuit, a transmission/reception circuit, and the like that are described based on common recognition in the technical field related to the present disclosure.

The transmitting/receiving section 220 may be configured as an integrated transmitting/receiving section, or may be configured by a transmitting section and a receiving section. The transmitting section may be configured by the transmission processing section 2211 and the RF section 222. The receiving section may be constituted by the reception processing section 2212, the RF section 222, and the measurement section 223.

The transmission/reception antenna 230 can be constituted by an antenna described based on common recognition in the technical field to which the present disclosure relates, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a transmission beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data acquired from the control section 210 or control information to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog transform on a bit string to be transmitted, and may output a base band signal.

Note that whether or not to apply DFT processing may be determined based on configuration of transform precoding. When transform precoding is enabled for a channel (for example, PUSCH), the transmitting/receiving section 220 (transmission processing section 2211) may perform DFT processing as the above-described transmission processing in order to transmit the channel by using a DFT-s-OFDM waveform, and if not, the DFT processing does not have to be performed as the transmission processing.

The transmitting/receiving section 220 (RF section 222) may perform modulation to a radio frequency band, filtering processing, amplification, and the like on the base band signal, and may transmit a signal in the radio frequency band via the transmission/reception antenna 230.

Meanwhile, the transmitting/receiving section 220 (RF section 222) may perform amplification, filtering processing, demodulation to a base band signal, and the like on the signal in the radio frequency band received by the transmission/reception antenna 230.

The transmitting/receiving section 220 (reception processing section 2212) may acquire user data and the like by applying reception processing such as analog-digital transform, FFT processing, IDFT processing (if necessary), filtering processing, demapping, demodulation, decoding (which may include error correction decoding), MAC layer processing, RLC layer processing, or PDCP layer processing on the acquired base band signal.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. A measurement result may be output to the control section 210.

Note that the transmitting section and the receiving section of the user terminal 20 in the present disclosure may include at least one of the transmitting/receiving section 220 and the transmission/reception antenna 230.

Note that the transmitting/receiving section 220 may receive the SMTC information.

The transmitting/receiving section 220 may receive a synchronization signal block (SSB) having an index in a range of values from 0 to smaller than 63 (for example, 0 to 25).

The control section 210 may control at least one of cell search and measurement using the SSB.

The one or more transmission candidate positions in the slot of the SSB may be arranged discontinuously (for example, FIGS. 7 and 8).

One or more slots each including one or more transmission candidate positions of the SSB may be arranged discontinuously in a half frame (for example, FIG. 9).

A set of predetermined number of consecutive slots each including one or more transmission candidate positions of the SSB may be arranged discontinuously in a half-frame (for example, FIG. 10).

The control section 210 may control measurement using the SSB in a predetermined window. A set including a plurality of windows discontinuously arranged in a time domain may be periodically arranged (for example, FIG. 11).

### (Hardware Configuration)

Note that the block diagrams that have been used to describe the above embodiments illustrate blocks in functional sections. These functional blocks (configuration sections) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (using wire, radio, or the like, for example) and using these plural apparatuses. The functional blocks may be implemented by combining software with the above-described single apparatus or the above-described plurality of apparatuses.

Here, the function includes, but is not limited to, deciding, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (configuration section) that causes transmission to function may be referred to as a transmitting section, a transmitter, and the like. In any case, as described above, the implementation method is not particularly limited.

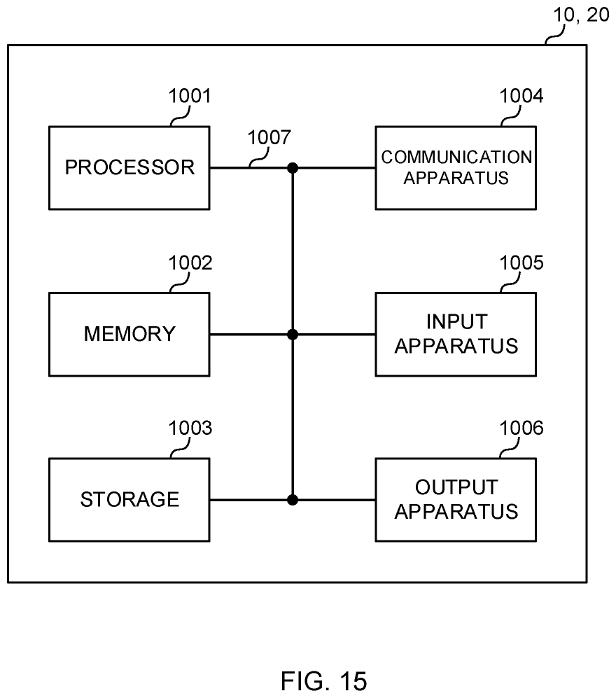

For example, the base station, the user terminal, or the like according to one embodiment of the present disclosure may function as a computer that executes processing a radio communication method in the present disclosure. FIG. 15 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may be configured to include one or a plurality of apparatuses illustrated in the drawings, or may be configured without including some apparatuses.

For example, although only one processor 1001 is illustrated, a plurality of processors may be provided.

Further, the processing may be executed by one processor, or the processing may be executed in sequence or using other different methods by two or more processors. Note that the processor 1001 may be implemented with one or more chips.

Each function of the base station 10 and the user terminal 20 is implemented by, for example, controlling communication via the communication apparatus 1004 by causing predetermined software (program) to be read on hardware such as the processor 1001 and the memory 1002 and thereby causing the processor 1001 to perform operation, or by controlling at least one of reading and writing of data in the memory 1002 and the storage 1003.

The processor 1001 may control the whole computer by, for example, running an operating system. The processor 1001 may be configured by a central processing unit (CPU) including an interface with peripheral equipment, a control device, an operation device, a register, and the like. For example, at least a part of the above-described control section 110 (210), transmitting/receiving section 120 (220), and the like may be implemented by the processor 1001.

Furthermore, the processor 1001 reads programs (program codes), software modules, data, and so on from at least one of the storage 1003 or the communication apparatus 1004 into the memory 1002, and executes various processing according to these. As the program, a program to cause a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may be implemented by, for example, at least one of a read only memory (ROM), an erasable programmable ROM (EPROM), an electrically EPROM (EEPROM), a random access memory (RAM), and/or other appropriate storage media. The memory 1002 may be referred to as a register, a cache, a main memory (primary storage apparatus), and the like. The memory 1002 can store a program (program code), a software module, and the like, which are executable for implementing the radio communication method according to one embodiment of the present disclosure.

The storage 1003 is a computer-readable recording medium, and may be constituted by, for example, at least one of a flexible disk, a floppy (registered trademark) disk, a magneto-optical disk (for example, a compact disc ROM (CD-ROM) and the like), a digital versatile disc, a Blu-ray (registered trademark) disk), a removable disk, a hard disk drive, a smart card, a flash memory device (for example, a card, a stick, a key drive), a magnetic stripe, a database, a server, and other appropriate storage media. The storage 1003 may be referred to as “secondary storage apparatus”.

The communication apparatus 1004 is hardware (transmitting/receiving device) for performing inter-computer communication via at least one of a wired network or a wireless network, and for example, is referred to as “network device”, “network controller”, “network card”, “communication module”, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmission/reception antenna 130 (230), and the like described above may be implemented by the communication apparatus 1004. The transmitting/receiving section 120 (220) may be mounted in a physically or logically separated manner with the transmitting section 120a (220a) and the receiving section 120b (220b).

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, and the like). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Furthermore, the base station 10 and user terminal 20 may include hardware such as a microprocessor, a Digital Signal Processor (DSP), an Application Specific Integrated Circuit (ASIC), a Programmable Logic Device (PLD), or a Field Programmable Gate Array (FPGA), and some or all of the functional blocks may be implemented by using the hardware. For example, the processor 1001 may be implemented with at least one of these pieces of hardware.

### (Modifications)

Note that terms described in the present disclosure and terms necessary for understanding the present disclosure may be replaced with terms that have the same or similar meanings. For example, a channel, a symbol, and a signal (signal or signaling) may be replaced interchangeably. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or a plurality of durations (frames) in the time domain. Each of the one or plurality of periods (frames) included in the radio frame may be referred to as a subframe. Further, the subframe may include one or more slots in the time domain. A subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, specific windowing processing performed by a transceiver in the time domain, and the like.

The slot may include one or a plurality of symbols (for example, orthogonal frequency division multiplexing (OFDM) symbol and single carrier frequency division multiple access (SC-FDMA) symbol) in the time domain. Also, a slot may be a time unit based on numerology.

A slot may include a plurality of mini slots. Each mini slot may include one or a plurality of symbols in the time domain. Further, the mini slot may be referred to as a sub slot. Each mini slot may include fewer symbols than a slot. PDSCH (or PUSCH) transmitted in a time unit larger than a mini slot may be referred to as PDSCH (PUSCH) mapping type A. A PDSCH (or PUSCH) transmitted using a mini slot may be referred to as “PDSCH (PUSCH) mapping type B”.

A radio frame, a subframe, a slot, a mini slot and a symbol all represent the time unit in signal communication. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as a TTI, a plurality of consecutive subframes may be referred to as a TTI, or one slot or one mini slot may be referred to as a TTI. That is, at least one of the subframe and TTI may be a subframe (1 ms) in the existing LTE, may be a period shorter than 1 ms (for example, one to thirteen symbols), or may be a period longer than 1 ms. Note that the unit to represent the TTI may be referred to as a “slot”, a “mini slot” and so on, instead of a “subframe”.

Here, a TTI refers to the minimum time unit of scheduling in radio communication, for example. For example, in the LTE system, a base station performs scheduling to allocate radio resources (a frequency bandwidth and transmission power that can be used in each user terminal and the like) to each user terminal in TTI units. Note that the definition of TTIs is not limited to this.

The TTI may be the transmission time unit of channel-encoded data packets (transport blocks), code blocks, or codewords, or may be the unit of processing in scheduling, link adaptation, or the like. Note that when TTI is given, a time interval (for example, the number of symbols) in which the transport blocks, the code blocks, the codewords, and the like are actually mapped may be shorter than TTI.

Note that, when one slot or one mini slot is referred to as a “TTI”, one or more TTIs (that is, one or more slots or one or more mini slots) may be the minimum time unit of scheduling. Also, the number of slots (the number of mini slots) to constitute this minimum time unit of scheduling may be controlled.

A TTI having a period of 1 ms may be referred to as usual TTI (TTI in 3GPP Rel. 8 to 12), normal TTI, long TTI, a usual subframe, a normal subframe, a long subframe, a slot, or the like. TTI shorter than normal TTI may also be referred to as shortened TTI, short TTI, partial TTI (or fractional TTI), a shortened subframe, a short subframe, a mini slot, a subslot, a slot, or the like.

Note that a long TTI (for example, a normal TTI, a subframe, or the like) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or a plurality of contiguous subcarriers in the frequency domain. The number of subcarriers included in the RB may be the same regardless of the numerology, and may be twelve, for example. The number of subcarriers included in the RB may be determined based on numerology.

Also, an RB may include one or more symbols in the time domain, and may be one slot, one mini slot, one subframe or one TTI in length. One TTI, one subframe, and the like each may be composed of one or more resource blocks.

Note that one or a plurality of RBs may be referred to as a physical resource block (PRB), a sub-carrier group (SCG), a resource element group (REG), a PRB pair, an RB pair, and the like.

A resource block may include one or a plurality of resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. The PRB may be defined in a certain BWP and be numbered within the BWP.

BWP may include BWP for UL (UL BWP) and BWP for DL (DL BWP). For the UE, one or a plurality of BWPs may be configured within one carrier.

At least one of the configured BWPs may be active, and the UE does not need to assume to transmit or receive a predetermined signal/channel outside the active BWP. Note that “cell”, “carrier”, and the like in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol duration, the length of cyclic prefix (CP), and the like can be variously changed.

Furthermore, information, a parameter, or the like described in the present disclosure may be represented in absolute values, represented in relative values with respect to predetermined values, or represented by using another corresponding information. For example, a radio resource may be indicated by a predetermined index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names assigned to these various channels and information elements are not restrictive names in any respect.

The information, signals, and the like described in the present disclosure may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Further, information, signals and the like can be output in at least one of a direction from higher layers to lower layers and a direction from lower layers to higher layers. Information, signals and so on may be input and output via a plurality of network nodes.

The information, signals and so on that are input and/or output may be stored in a specific location (for example, in a memory), or may be managed in a management table. The information, signal, and the like to be input and output can be overwritten, updated or appended. The output information, signal, and the like may be deleted. The information, signals and so on that are input may be transmitted to other pieces of apparatus.

Notification of information may be performed not only by using the aspects/embodiments described in the present disclosure but also using another method. For example, notification of information in the present disclosure may be performed by using physical layer signaling (for example, downlink control information (DCI), uplink control information (UCI)), higher layer signaling (for example, radio resource control (RRC) signaling, broadcast information (master information block (MIB), system information block (SIB), or the like), medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of MAC signaling may be performed using, for example, a MAC control element (MAC CE).

Further, notification of predetermined information (for example, notification of “being X”) is not limited to explicit notification but may be performed implicitly (for example, by not performing notification of the predetermined information or by performing notification of another piece of information).

Decisions may be made in values represented by one bit (0 or 1), may be made in Boolean values that represent true or false, or may be made by comparing numerical values (for example, comparison against a predetermined value).

Software, whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology and the wireless technology is included within the definition of a transmission medium.

The terms “system” and “network” used in the present disclosure can be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “ base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier” may be used interchangeably. A base station may be referred to as a term such as a macro cell, a small cell, a femto cell, a pico cell, and the like.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small remote radio head (RRH) for indoors). The term “cell” or “sector” refers to a part or the whole of a coverage area of at least one of a base station and a base station subsystem that perform a communication service in this coverage.

In the present disclosure, the terms such as mobile station “(MS)”, “user terminal”, “user equipment (UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

At least one of the base station and the mobile station may be referred to as a transmitting apparatus, a receiving apparatus, a radio communication apparatus, and the like. Note that at least one of the base station and the mobile station may be a device mounted on a moving body, a moving body itself, and the like. The moving body may be a transportation (for example, a car, an airplane and the like), an unmanned moving body (for example, a drone, an autonomous car, and the like), or a (manned or unmanned) robot. Note that at least one of the base station and the mobile station also includes an apparatus that does not necessarily move during a communication operation. For example, at least one of the base station and the mobile station may be an Internet of Things (IoT) device such as a sensor.

Furthermore, a base station in the present disclosure may be interpreted as a user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In the case, the user terminal 20 may have the function of the above-described base station 10. Further, terms such as “uplink” and “downlink” may be replaced with terms corresponding to communication between terminals (for example, “side”). For example, the uplink channel, the downlink channel, and the like may be replaced with a side channel.

Similarly, the user terminal in the present disclosure may be replaced with a base station. In this case, the base station 10 may be configured to have the above-described functions of the user terminal 20

In the present disclosure, an operation performed by a base station may be performed by an upper node thereof in some cases. In a network including one or a plurality of network nodes including the base station, it is clear that various operations performed to communicate with terminals may be performed by the base station, one or more network nodes other than the base station (for example, mobility management entity (MME), serving-gateway (S-GW), and the like are conceivable, but there is no limitation), or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, regarding the methods described in the present disclosure, elements of various steps are presented using an illustrative order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded based on these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on”.

Any reference to an element using designations such as “first” and “second” used in the present disclosure does not generally limit the amount or order of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may include a wide variety of operations. For example, “determining (deciding)” may be regarded as “determining (deciding)” of judging, calculating, computing, processing, deriving, investigating, looking up, search, inquiry (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

Furthermore, “determining” may be replaced with “assuming”, “expecting”, “considering”, and the like.

As used in the present disclosure, the terms “connected” and “coupled”, or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be replaced with “access”.

As used in the present disclosure, when two elements are connected, these elements may be considered to be “connected” or “coupled” to each other by using one or more electrical wires, cables, printed electrical connections, and the like, and, as some non-limiting and non-inclusive examples, by using electromagnetic energy and the like having wavelengths in the radio frequency, microwave, and optical (both visible and invisible) domains.

In the present disclosure, the phrase “A and B are different” may mean “A and B are different from each other”. Note that the description may mean that “A and B are different from C”. Terms such as “leave”, “coupled”, or the like may also be interpreted in the same manner as “different”.

When the terms such as “include”, “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, when articles, such as “a”, “an”, and “the” are added in English translation, the present disclosure may include the plural forms of nouns that follow these articles.

Now, although invention according to the present disclosure has been described above in detail, it is obvious to those skilled in the art that the invention according to the present disclosure is by no means limited to the embodiments described in the present disclosure. The invention according to the present disclosure can be embodied with various corrections and in various modified aspects, without departing from the spirit and scope of the invention defined based on the description of claims. Consequently, the description of the present disclosure is provided only for the purpose of explaining examples, and should by no means be construed to limit the invention according to the present disclosure in any way.

This application is based on Japanese Patent Application No. 2019-094130 filed on May 17, 2019. The contents of this are all incorporated herein.

1. A user terminal comprising:
a receiving section that receives a synchronization signal block (SSB) having an index in a range of values from 0 to greater than 63 in a predetermined frequency range; and
a control section that controls at least one of cell search or measurement using the SSB.

2. The user terminal according to claim 1, wherein one or more transmission candidate positions in the slot of the SSB are discontinuously arranged.

3. The user terminal according to claim 1, wherein one or more slots each including one or more transmission candidate positions of the SSB are arranged discontinuously in a half frame.

4. The user terminal according to claim 1, wherein a set of a predetermined number of consecutive slots each including one or more transmission candidate positions of the SSB is arranged discontinuously in a half frame.

5. The user terminal according to claim 1, wherein
the control section controls measurement using the SSB in a predetermined window, and
a set including a plurality of windows discontinuously arranged in a time domain is periodically arranged.

6. A radio communication method for a user terminal, the method comprising:
receiving a synchronization signal block (SSB) having an index in a range of values from 0 to greater than 63 in a predetermined frequency range; and
controlling at least one of cell search or measurement using the SSB.

7. The user terminal according to claim 2, wherein one or more slots each including one or more transmission candidate positions of the SSB are arranged discontinuously in a half frame.

8. The user terminal according to claim 2, wherein a set of a predetermined number of consecutive slots each including one or more transmission candidate positions of the SSB is arranged discontinuously in a half frame.

9. The user terminal according to claim 2, wherein
the control section controls measurement using the SSB in a predetermined window, and
a set including a plurality of windows discontinuously arranged in a time domain is periodically arranged.

10. The user terminal according to claim 3, wherein
the control section controls measurement using the SSB in a predetermined window, and
a set including a plurality of windows discontinuously arranged in a time domain is periodically arranged.

11. The user terminal according to claim 4, wherein
the control section controls measurement using the SSB in a predetermined window, and
a set including a plurality of windows discontinuously arranged in a time domain is periodically arranged.
